(19) United States
(12) Patent Application Publication
(10) Pub. No.: US 2008/0267229 A1
(43) Pub. Date: Oct. 30, 2008

(54) Optical fiber, optical fiber production method and optical fiber production system

(75) Inventors: Seiji Kojima, Hitachi (JP); Akihito Hongo, Hitachi (JP); Kazumasa Ohsono, Hitachi (JP); Bing Yao, Hitachi (JP); Kazuya Saito, Nagoya (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignees: HITACHI CABLE, LTD., Tokyo (JP); TOYOTA SCHOOL FOUNDATION, Nagoya-shi (JP)

(21) Appl. No.: 12/149,025

(22) Filed: Apr. 25, 2008

(30) Foreign Application Priority Data
Apr. 26, 2007 (JP) 2007-117277

(51) Int. Cl. H01S 3/30; G02B 6/02

(52) U.S. Cl. 372/6; 385/123

(57) ABSTRACT

An optical fiber includes a rare-earth element-added core for serving as a gain medium, and a cladding formed on a periphery of the core. Pump light propagated through the cladding is coupled into the core. The cladding is in an undulation shape in the longitudinal direction of the cladding. The undulation shape of the cladding is formed according to a grating period at which the pump light is totally reflected and propagated in the cladding. The core includes an undulation shape in a longitudinal direction of the core. The cladding includes an undulating inner cladding, and an outer cladding provided on a periphery of the inner cladding. The core and/or the cladding is circular or abnormally circular in its transverse cross section.

The present application is based on Japanese patent application No. 2007-117277 filed on Apr. 26, 2007, the entire contents of which are incorporated herein by reference.

### BACKGROUND OF THE INVENTION

1. Field of the Invention

The present invention relates to an optical fiber, such as a fiber laser and a fiber amplifier, with a gain core that serves as a gain medium and, particularly, to an optical fiber for efficiently coupling pump light into its gain core.

2. Description of the Related Art

There is a demand for development of a higher-power low-cost light source, for the purpose of its application to laser processing or medical use. For this demand, optical amplifiers such as a fiber laser and a fiber amplifier are notable because they can easily extract single mode laser light with high efficiency.

The research and development of conventional optical fibers used in such fiber laser or fiber amplifier have been done.

JP-B-3039993 discloses that when an optical fiber has its circularly symmetrical cross section, skew rays conveying most of pump light propagating through inner cladding do not cross the fiber core because they are concentrated in a circular region around the core.

Because the core is positioned in the middle, i.e., apart from position of most of pump light, such circularly symmetrical optical fiber structure can only relatively non-efficiently use available pump light. A non-uniform mode distribution in the circularly symmetrical fiber results from its geometrical structure, and the circular geometrical structure and middle core position are non-efficient in efficiently utilizing pump light. For that reason, in a fiber laser or a fiber amplifier, several measures are proposed to efficiently couple the pump light into its gain core. For example, see Martin H. Muendel, “Optimal inner cladding shapes for double-clad fiber lasers”, Conference on Laser and Electro-Optics, OSA Technical Digest Series, pp. 209, 1996, and H. Zellmer et al. “Double-clad Fiber Laser with 30 W Output Power”, OSA TOPS Vol. 16 Optical Amplifiers and Their Applications, pp. 137-140, 1997.

The techniques of JP-B-3039993 and Martin H. Muendel are devised such that the cross section of an inner cladding is formed non-rectangular or convex polygonal, where the inner cladding for longitudinally (axially) propagating pump light includes a rare-earth element-added core that serves as a gain medium, and thereby creates a non-uniform field in the pump light-propagating inner cladding so as to concentrate various propagation modes into the core inside the inner cladding. Consequently, more modes cross the core, so that the coupling efficiency of the pump light and the gain medium can be increased to efficiently couple the pump light into the gain core.

Also, H. Zellmer et al. “Double-clad Fiber Laser with 30 W Output Power”, OSA TOPS Vol. 16 Optical Amplifiers and Their Applications, pp. 137-140, 1997 discloses that pump light propagating in the inner cladding can be efficiently coupled to the gain core by forming the installation shape of the optical fiber into a kidney shape, as illustrated in FIG. 7.

As described above, in the prior arts, pump light is efficiently coupled into the gain core, by optimizing geometrical structure of optical fiber cross section or optical fiber installation shape, in a multi-cladding optical fiber with a gain core.

See also JP-A-11-84150, and Vengsarkar, A. M. et al. “Long-Period Fiber Gratings as Band-Rejection Filters”, JOURNAL OF LIGHTWAVE TECHNOLOGY, Vol. 14, No. 1 pp. 58-65, 1996.

Generally, optical fibers with the modified inner cladding shape like JP-B-3039993 and Martin H. Muendel are optimized in cross section of an optical fiber preform, to fabricate an optical fiber with its cross section optimized by pulling the optical fiber preform. However, the structure of the optical fiber preform as disclosed in JP-B-3039993 requires an advanced fabrication technique in comparison to typical optical fiber fabrication, and time and cost for processing or assembling the optical fiber preform.

As disclosed by H. Zellmer et al., in order to optimize the installation shape of the optical fiber, it is necessary to form the optical fiber used as a transmission line into the kidney shape and fix the shape for optimizing coupling efficiency. This causes a limitation in installation area when built into an apparatus, and makes it not easy to use. Also, if the length of the optical fiber is short, it is difficult to have an optimal installation form thereof. Thus, it is necessary to have a given length of the optical fiber for obtaining the optimal installation form thereof.

### SUMMARY OF THE INVENTION

Accordingly, it is an object of the present invention to provide an optical fiber, an optical fiber production method and an optical fiber production system, capable of efficiently coupling pump light into a gain core without optimizing the geometrical structure in cross section of the optical fiber or the installation form of the optical fiber.

(1) According to one embodiment of the invention, an optical fiber comprises:

a rare-earth element-added core for serving as a gain medium; and

a cladding formed on a periphery of the core,

wherein pump light propagated through the cladding is coupled into the core, and the cladding is in an undulation shape in a longitudinal direction of the cladding.

In the above embodiment (1), the following modifications and changes can be made.

(i) The undulation shape of the cladding is formed according to a grating period at which the pump light is totally reflected and propagated in the cladding.

(ii) The core is in an undulation shape in a longitudinal direction of the core.

(iii) The cladding comprises an undulating inner cladding, and an outer cladding provided on a periphery of the inner cladding.

(iv) The core and/or the cladding is circular or abnormally circular in its transverse cross section.

(2) According to another embodiment of the invention, a method for producing an optical fiber comprising a rare-earth element-added core for serving as a gain medium, and a cladding formed on a periphery of the core, pump light propagated through the cladding being coupled into the core, and the cladding being in an undulation shape in a longitudinal direction of the cladding, comprises:

during pulling an optical fiber perform, periodically applying high-power heat energy such as CO₂ laser to the core and/or the cladding to form undulation therein.

(3) According to another embodiment of the invention, a system for producing an optical fiber comprising a rare-earth element-added core for serving as a gain medium, and a cladding formed on a periphery of the core, pump light propagated through the cladding being coupled into the core, and the cladding being in an undulation shape in a longitudinal direction of the cladding, comprises:

an undulation-forming section for, during pulling an optical fiber perform, periodically applying high-power heat energy such as CO₂ laser to the core and/or the cladding.

By the exemplary embodiments of the invention, it is possible to efficiently couple pump light into the gain core without optimizing the geometrical structure in cross section of the optical fiber or the installation form of the optical fiber.

### BRIEF DESCRIPTION OF THE DRAWINGS

The preferred embodiments according to the invention will be explained below referring to the drawings, wherein:

FIG. 1A is a longitudinal cross-sectional view illustrating an optical fiber in a first preferred embodiment according to the invention, and FIG. 1B is a transverse cross-sectional view taken along line 1B-1B of FIG. 1A;

FIG. 2 is a schematic view showing an undulation-forming section and one example of a method for producing the optical fiber shown in FIG. 1;

FIG. 3 is a schematic view showing an optical fiber production system in the embodiment;

FIG. 4A is a longitudinal cross-sectional view illustrating an optical fiber in a second embodiment, and FIG. 4B is a transverse cross-sectional view taken along line 4B-4B of FIG. 4A;

FIGS. 5A-5C are transverse cross-sectional views illustrating modifications respectively of the optical fibers in the embodiments;

FIG. 6A is a longitudinal cross-sectional view illustrating an optical fiber in a third embodiment, and FIG. 6B is a transverse cross-sectional view taken along line 6B-6B of FIG. 6A;

FIG. 7 is a view showing an installed state of a conventional optical fiber; and

FIG. 8 is a diagram showing the relationship between grating period and radiation wavelength (taken from Vengsarkar, A. M. et al. “Long-Period Fiber Gratings as Band-Rejection Filters”, JOURNAL OF LIGHTWAVE TECHNOLOGY, Vol. 14, No. 1 pp. 58-65, 1996).

### DETAILED DESCRIPTION OF THE PREFERRED EMBODIMENTS

From Martin H. Muendel, “Optimal inner cladding shapes for double-clad fiber lasers”, Conference on Laser and Electro-Optics, OSA Technical Digest Series, pp. 209, 1996, it has been found that the efficiency of absorbing pump light into the core is enhanced by bending an optical fiber and periodically varying the propagation mode of pump light propagated through the optical fiber. Also, according to Martin H. Muendel, an optical fiber with 10 cm winding radius has an absorption rate of 10%, whereas a kidney-shaped (r=2.5 cm) optical fiber has an enhanced absorption rate on the order of 60%. This is because mode mixing is formed at position at which optical fiber bend is varied, and means that periodic shape variation contributes largely to enhancement of excitation efficiency.

The present inventors have conducted earnest research based on this knowledge, and consequently completed the invention in order to solve the above problems.

The preferred embodiments according to the invention will be explained below by way of the accompanying drawings.

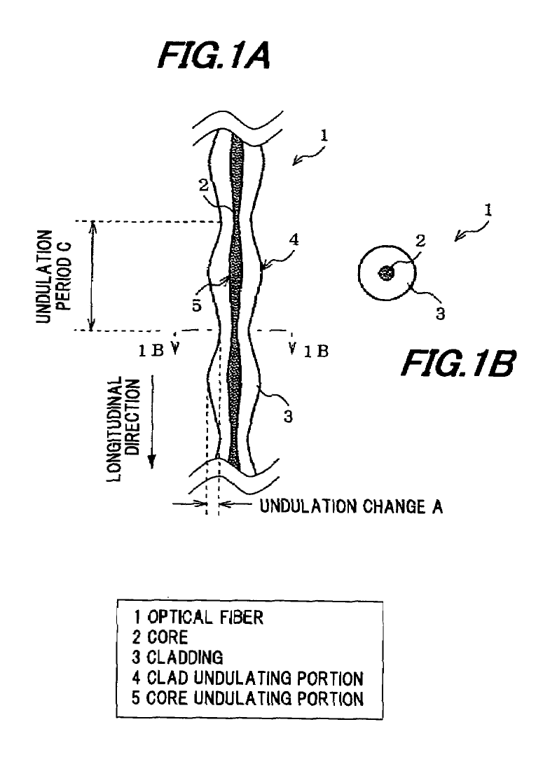

FIG. 1A is a longitudinal cross-sectional view illustrating an optical fiber in a first preferred embodiment according to the invention, and FIG. 1B is a transverse cross-sectional view taken along line 1B-1B of FIG. 1A.

As shown in FIGS. 1A and 1B, an optical fiber 1 in the first embodiment is used in fiber lasers or fiber amplifiers, and comprises a rare-earth element-added core (gain core) 2 serving as its gain medium, and cladding 3 for surrounding that core 2, and receiving and longitudinally propagating pump light (excitation light), and is formed in an undulation shape by causing the cladding 3 to comprise longitudinal undulating portion 4.

Namely, the optical fiber 1 comprises the core 2, and the cladding 3 formed on the outer periphery of the core 2, and absorbs into the core 2 and amplifies pump light propagated through the cladding 3.

The core 2 comprises quartz added with a refractive index-increasing material such as Ge, and with a rare-earth element (or rare-earth material) such as Nd, Yb, Er, Th, or the like.

The cladding 3 has a refractive index lower than that of the core 2, and comprises quartz added with a refractive index-decreasing material such as F. Here, the undulation shape refers to a periodic waveform formed on an outer periphery of the cladding 3 so that the cladding diameter is longitudinally and continuously thin and thick. The undulating portion 4 may be formed at least on peripheral portions on both sides of the cladding 3, but may also be formed on the entire periphery of the cladding 3.

The period (undulation period) C of the undulation shape of the cladding 3 is set to a grating period so as not to radiate out from the optical fiber 1 (cladding 3) and attenuate pump light propagated in the optical fiber 1.

Regarding the undulation period formed in the longitudinal direction of an optical fiber, grating is formed according to that period, as disclosed in JP-A-11-84150. The purpose of JP-A-11-84150 is to periodically vary the core diameter of the optical fiber in the longitudinal direction of the optical fiber, to thereby mix a core propagation mode and a cladding propagation mode, and radiate out from the core and attenuate particular wavelength light.

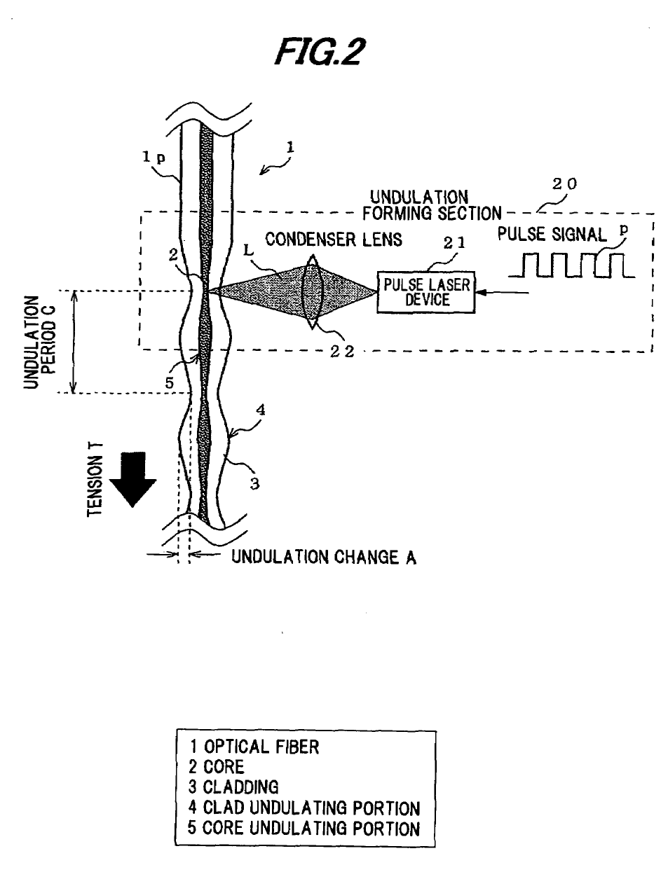

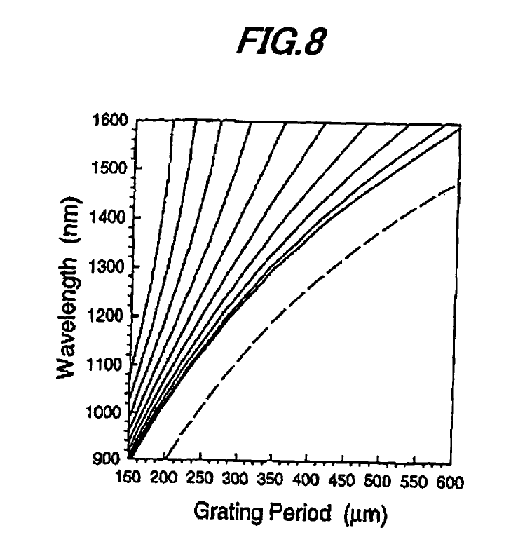

Generally, the wavelength (central wavelength for long period grating: radiation wavelength) radiating light out from the core is determined by the efficiency of mixing the core mode and the cladding propagation mode. For example, the relationship between undulation period (grating period) and the radiation wavelength as disclosed in Vengsarkar, A. M. et al. “Long-Period Fiber Gratings as Band-Rejection Filters”, JOURNAL OF LIGHTWAVE TECHNOLOGY, Vol. 14, No. 1 page 59 (FIG. 2), 1996 is shown in FIG. 8, in which at grating periods of not more than 200 μm, there are plural radiation wavelengths at wavelengths of at least not more than 1000 nm, and these radiation wavelengths cause light to be radiated out from the core.

In contrast, the optical fiber 1 has pump light wavelength varied according to rare-earth material added to the core 2. For example, in the case of a fiber laser or fiber amplifier having its core added with Yb, the pump light wavelength is used by being matched to its absorption property and set in the range of 900-1000 nm (particularly, matched to an absorption peak and set at 915 or 975 nm).

Thus, in the case of the optical fiber 1 having the core 2 added with Yb, to suppress an increase in transmission loss due to light being radiated out from the core, the period of the longitudinal undulating portion 4 formed in the cladding 3 may be set to a grating period such that pump light used in the range of 900-1000 nm is not radiated but is totally reflected and propagated in the cladding 3.

This allows pump light to be efficiently absorbed into the rare-earth element-added core 2 by the undulation shape without being radiated out from the cladding 3 in the optical fiber 1.

Although the rare-earth material added to the core 2 is Yb as one example, other rare-earth materials such as Er may be added to the core 2, in which case by forming undulation period C in the cladding 3 so that pump light set in a wavelength range (e.g., Er: 980-1480 nm) used is not at radiation wavelength as in the above case, the pump light can be efficiently absorbed into the core 2.

The undulation shape change (undulation change) A of the cladding 3 is a difference between maximum and minimum outer diameter of the cladding 3.

Further, in the optical fiber 1, the core 2 has an undulation shape formed of longitudinal undulating portion 5. The undulation shape period of the core 2 may be the same as undulation period C of the cladding 3. The undulation shape change of the core 2 is smaller than undulation change A of the cladding 3. In the optical fiber 1, the core 2 and the cladding 3 both have a circular transverse cross section.

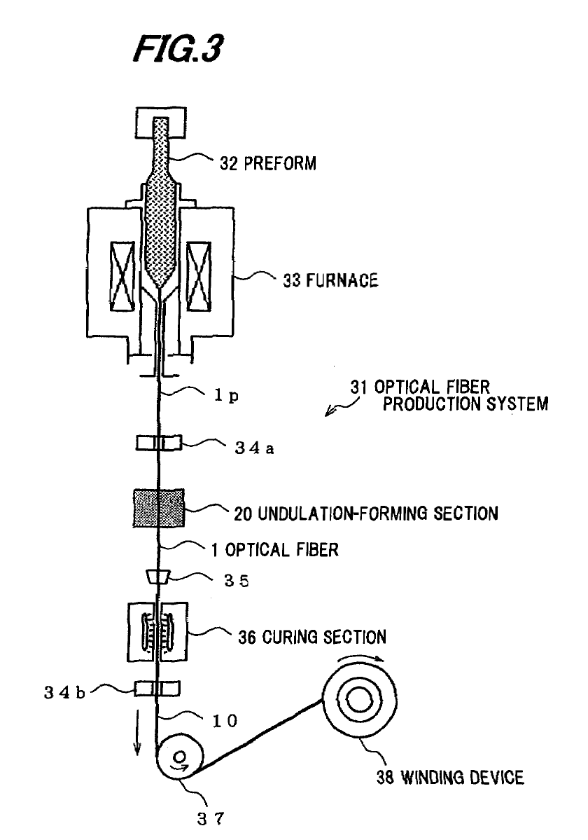

Next explained with FIG. 3 is an optical fiber production system suitable for producing the optical fiber 1. As shown in FIG. 3, an optical fiber production system 31 in this embodiment is substantially the same in construction as conventional optical fiber production system, except for a later-described undulation-forming section 20.

This optical fiber production system 31 pulls an optical fiber preform 32 downwardly, and passes it through undulation-forming section 20 to form an optical fiber 1, and covers that optical fiber 1 with a sheath material, and winds the optical fiber (optical fiber core wire 10) covered with the sheath material.

The optical fiber production system 31 comprises a furnace 33 for heating optical fiber preform 32, a first outer diameter measuring instrument 34a for measuring outer diameter of an optical fiber fused and pulled in the furnace 33, an undulation-forming section 20 for forming undulating portion 4 of FIG. 1 in the optical fiber passed through the first outer diameter measuring instrument 34a resulting in an optical fiber 1, a die 35 (die for fiber sheath resin) for covering the optical fiber 1 with a sheath material, a curing section (sheath resin curing device) 36 for curing the sheath material resulting in an optical fiber core wire 10, a second outer diameter measuring instrument 34b for measuring outer diameter of the optical fiber core wire 10 passed through the curing section 36, a turn pulley 37 for changing the direction of the optical fiber core wire 10 and passing it downstream, and a winding device 38 for winding the optical fiber core wire 10 from the turn pulley 37.

The curing section 36 may be altered appropriately according to kinds of sheath materials. Used for thermosetting resin such as polyimide resin is a heater, while used for UV (ultraviolet) cured resin is a UV lamp. The winding device 38 also serves as a tensioning means for tensioning the optical fiber 1 or the optical fiber core wire 10 during pulling.

As one example of a method for producing the optical fiber 1 of FIGS. 1A and 1B in this manner, there is a method using the optical fiber production system 31 with the undulation-forming section 20 installed between the first outer diameter measuring instrument 34a and the die 35. This allows the optical fiber 1 to be produced that is matched to desired outer diameter.

Here, one example of the undulation-forming section 20 is explained in more detail in FIG. 2.

As shown in FIG. 2, the undulation-forming section 20 is for periodically (intermittently) applying high-power heat energy to the optical fiber during pulling. This undulation-forming section 20 comprises plural pulse laser devices 21 for applying pulse laser L as plural heat energy sources provided around the optical fiber during pulling, and a condenser lens 22 provided to be freely moved forwardly and backwardly between each pulse laser device 21 and the optical fiber 1 during pulling, for collecting pulse laser light L.

The laser built in the pulse laser device 21 may be a CO₂ laser, YAG laser, semiconductor laser, fiber laser, or the like, capable of locally supplying (applying) high-power heat energy to the optical fiber during pulling, and having a light-collecting property.

The pulse laser device 21 periodically applies high-power heat energy to the optical fiber during pulling by pulse signal p being input thereinto that has a pulse width corresponding to ½ of undulation period C, and a pulse height corresponding to undulation change A, taking account of pulling speed described later.

A method for producing the optical fiber 1 is explained along with operation of the optical fiber production system 31.

First, optical fiber preform 32 is heated, fused and pulled vertically and downwardly in furnace 33. The pulling is followed by measuring with first outer diameter measuring instrument 34a outer diameter of optical fiber 1p immediately after pulling, while controlling temperature inside furnace 33, tension T and pulling speed (winding speed) in winding device 38.

And when optical fiber 1p immediately after pulling is passed through undulation-forming section 20, pulse laser light L corresponding to pulse signal p is applied from the pulse laser device 21, to apply local and periodic high-power heat energy to the optical fiber 1p immediately after pulling.

Applying local high-power heat energy to the optical fiber during pulling fuses and softens that portion of the optical fiber. In this case, since tension T is applied to the optical fiber by winding device 38, that area fused is stretched and thinned.

In the first embodiment, the focal point of pulse laser light L applied to the optical fiber 1p immediately after pulling is positioned near the axis of the core 2 by moving condenser lens 22 forwardly or backwardly. That is, in the first embodiment, pulse laser light L is applied to the core 2 and cladding 3.

This allows a longitudinal undulating portion 4 to be formed on the respective peripheral portions of the core 2 and cladding 3, resulting in the optical fiber 1.

When the undulating portion 4 is formed, undulation period C or undulation change A may be varied by pulse period, laser energy, tension T etc. These may be appropriately varied to vary undulation period C or undulation change A, and thereby vary the pump light-absorbing efficiency into a desired value.

Subsequently, the optical fiber 1 is passed through die 35 and curing section 36 to be covered with a sheath material, resulting in optical fiber core wire 10, which is wound by winding device 38, resulting in a product.

The function of the first embodiment is explained.

In the optical fiber 1, pump light of a semiconductor laser, for example, is applied from cladding 3 at an incident end, and amplified inside the optical fiber 1. 2 FBGs (Fiber Bragg Gratings) formed at a specified distance from the incident end serve as a total reflection mirror and an output mirror of the laser resonator, to produce laser oscillation light, which is output from an output end. That is, the optical fiber 1 can be used as a fiber laser.

Because the cladding 3 of the optical fiber 1 has undulation shape comprising longitudinal undulating portion 4, the optical fiber 1 allows enhancement in pump light-absorbing efficiency, and can efficiently couple pump light into the core 2, compared with a conventional optical fiber with its longitudinally smooth cladding.

Particularly, in the optical fiber 1, the period C of the undulation shape of the cladding 3 is set to a grating period such that pump light propagated in the optical fiber 1 is not radiated out from the optical fiber 1 but is totally reflected and propagated in the cladding 3.

This allows pump light to be efficiently absorbed into the rare-earth element-added core 2 by the undulation shape without being radiated out from the cladding 3 in the optical fiber 1.

Further, because in the optical fiber 1, the core 2 as well as the undulating cladding 3 has an undulation shape formed of longitudinal undulating portion 5, it is also possible to vary the propagation mode of the core 2 into a desired mode.

Also, the optical fiber 1 also serves as an optical amplifier such as a fiber amplifier, when resonator structure with gratings is not formed, and signal light matched to wavelength of induced emission light is superimposed on pump light and propagated through the optical fiber 1.

The optical fiber 1 has its fiber structure for effectively utilizing pump light. The primary purpose of the optical fiber 1 is not to vary the propagation mode of the rare-earth element-added core, but to enhance pump light-absorbing efficiency, i.e., to vary the pump light propagation mode with simple structure having undulating cladding 3.

Accordingly, according to the optical fiber 1, it is possible to efficiently couple pump light into the gain core with the simple structure without the conventional need to optimize geometrical structure of optical fiber cross-sectional shape or installation shape of the optical fiber.

This allows the optical fiber 1 to have its fiber structure for effectively utilizing pump light, and use of the optical fiber 1 makes it possible to realize optimal optical fiber structure at low cost that may be used in fiber lasers or fiber amplifiers.

Also, according to the optical fiber 1 production method, it is possible to easily and accurately produce undulating optical fiber 1, only by providing undulation-forming section 20 in the conventional optical fiber production system.

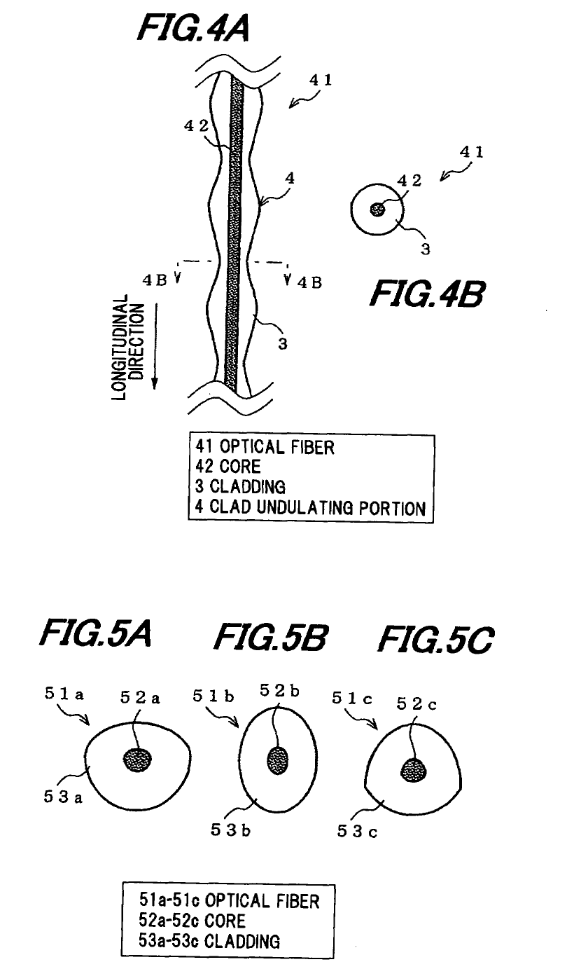

As described above, in the optical fiber in this embodiment, enhancement of at least pump light-absorbing efficiency only has to be achieved. To this end, as in optical fiber 41 in a second embodiment shown in FIGS. 4A and 4B, only cladding 3 for propagating pump light may have undulation shape, but core 42 does not have undulation shape.

The optical fiber 41 may be produced by controlling heat energy supply position (pulse laser light L focal position), such as by appropriately moving condenser lens 22 backwardly compared to the FIG. 2 state, relative to the optical fiber during pulling. That is, in the second embodiment, pulse laser light L is applied to the cladding 3 only.

Also, although in the optical fiber 1, the core 2 and the cladding 3 are explained that both have a circular transverse cross section, the transverse cross section may be in an elliptic shape slightly bulging on one side, an elliptic shape, or an abnormally circular shape significantly bulging on one side, as in optical fibers 51a-51c of FIGS. 5A-5C respectively. In this case, the advantageous effect of JP-B-3039993 can also be obtained, to further enhance pump light-absorbing efficiency, in which case cores 52a-52c may be not in an abnormally circular shape as in cladding 53a-53c in FIGS. 5A-5C, but be in a circular shape.

These optical fibers 51a-51c may be produced by forming the transverse cross section of an optical fiber preform in an abnormally circular shape when produced, or by controlling heat energy supply position, such as by appropriately moving condenser lens 22 in FIG. 2 forwardly or backwardly, relative to the optical fiber during pulling.

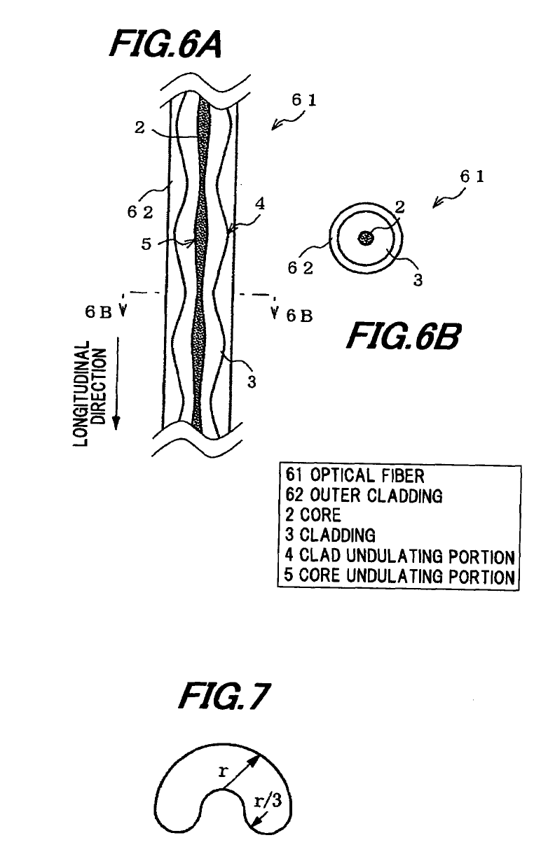

As in optical fiber 61 in a third embodiment shown in FIGS. 6A and 6B, in addition to construction of the optical fiber 1 of FIG. 1, an outer cladding 62 may be further provided.

In the optical fiber 61, the cladding comprises an inner cladding 3 (cladding 3 of FIGS. 1A and 1B), and a longitudinal smooth outer cladding 62 provided on the outer periphery of that inner cladding 3, and having lower refractivity than the inner cladding 3. This outer cladding 62 has a circular transverse cross section, but may have an abnormally circular transverse cross section, as in FIGS. 5A-5C.

The optical fiber 61 can more efficiently confine pump light therein, compared to the optical fiber 1 of FIG. 1.

Although in the undulation-forming section 20 explained in FIG. 2, the pulse laser device 21 is used as the heat energy source, a heater, a high frequency heater, or the like, may be used as the heat energy source that can intermittently apply high-power heat energy to the optical fiber during pulling.

Also, the undulation-forming section may be provided with a laser for emitting continuous laser light as the heat energy source, the condenser lens 22 in FIG. 2, and plural chopping means provided between the condenser lens 22 and the optical fiber during pulling, for chopping continuous laser light.

As the chopping means, there is a mechanical chopper comprising a rotatable disc, and plural slits formed in the circumferential direction of that disc. In this case, an undulating portion with a desired undulation period C is formed in the optical fiber by controlling rotational speed of the disc, and pulling speed.

The invention may also be applied to an optical fiber having a special geometrical structure as disclosed in JP-B-3039993. For an optical fiber having such a geometrical structure, it is possible to ensure enhancement in coupling efficiency without optimizing installation shape of the optical fiber.

Although in the above embodiments, pulse laser light L is applied to the core 2 and cladding 3, or cladding 3 only, pulse laser light L may be applied to the core 2 only, in which case the function and effect similar to the above can also be obtained.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An optical fiber, comprising:
a rare-earth element-added core for serving as a gain medium; and
a cladding formed on a periphery of the core,
wherein pump light propagated through the cladding is coupled into the core, and the cladding comprises an undulation shape in a longitudinal direction of the cladding.

2. The optical fiber according to claim 1, wherein:
the undulation shape of the cladding is formed according to a grating period at which the pump light is totally reflected and propagated in the cladding.

3. The optical fiber according to claim 1, wherein:
the core comprises an undulation shape in a longitudinal direction of the core.

4. The optical fiber according to claim 1, wherein:
the cladding comprises an undulating inner cladding, and an outer cladding provided on a periphery of the inner cladding.

5. The optical fiber according to claim 1, wherein:
the core and/or the cladding is circular or abnormally circular in its transverse cross section.

6. A method for producing an optical fiber comprising a rare-earth element-added core for serving as a gain medium, and a cladding formed on a periphery of the core, pump light propagated through the cladding being coupled into the core, and the cladding comprising an undulation shape in a longitudinal direction of the cladding,
the method comprising:
during pulling an optical fiber preform, periodically applying high-power heat energy to the core and/or the cladding to form undulation therein.

7. A system for producing an optical fiber comprising a rare-earth element-added core for serving as a gain medium, and a cladding formed on a periphery of the core, pump light propagated through the cladding being coupled into the core, and the cladding comprising an undulation shape in a longitudinal direction of the cladding,
the system comprising:
an undulation-forming section for, during pulling an optical fiber preform, periodically applying high-power heat energy to the core and/or the cladding.

8. The optical fiber according to claim 1, wherein:
the optical fiber comprises a fiber laser or a fiber amplifier.

9. The method according to claim 6, wherein:
the optical fiber comprises a fiber laser or a fiber amplifier.

10. The system according to claim 7, wherein:
the optical fiber comprises a fiber laser or a fiber amplifier.
